(19) United States
(12) Patent Application Publication
(10) Pub. No.: US 2008/0056897 A1
(43) Pub. Date: Mar. 6, 2008

(54) Counter rotating rotor head

(76) Inventor: Thomas Anderson, Bellport, NY (US)

Correspondence Address: MICHAEL RIES, 318 PARKER PLACE, OSWEGO, IL, 60543, US

(21) Appl. No.: 11/516,087

(22) Filed: Sep. 6, 2006

(51) Int. Cl. F03D 1/02

(52) U.S. Cl. 416/128

(57) ABSTRACT

A device and method having a rotor head with a rotor input/output shaft, a rotor drive cap, an upper rotor/propeller hub, upper blades and a driver bevel gear; an idler assembly connects the upper rotor/propeller hub to a lower rotor/propeller hub, lower blades and an idler bevel gear; and a static assembly with a main rotor shaft, an idler pinion carrier and an idler pinion shaft. The rotor head and the idler assembly rotate utilizing bevel gear idlers in opposite directions about the static assembly to cause the upper blades and lower blades to rotate in opposite directions.

### TECHNICAL FIELD & BACKGROUND

The present invention generally relates to the field of rotating blades. More specifically, the present invention relates to counter rotating blades with one main support.

It has long been known in the air, rotorcraft and marine industries that counter-rotating blades are superior to a single rotor disc, as they double the working blade area, while recovering energy lost to the swirl of air emerging from a single disc. In rotorcraft applications they also negate the need for a tail rotor system, another huge asset. Despite these advantages existing designs have found limited success because of their complex, inefficient drive trains, and rely on their drive shafts to transmit both thrust and rotary forces.

The present invention is directed to a counter rotating device and method that is a counter rotating rotor head. In one embodiment, the elegant, robust design transmits thrust force to a structure of a vehicle through a fixed main support or main rotor shaft and thrust bearings which may be double row angular contact ball thrust bearings or tapered roller thrust bearings. This design allows a single shaft to transmit rotary force to both rotors. Existing designs accomplish this through complex, inefficient drive trains and rely upon more then one drive shaft to transmit both thrust and rotary loads.

In the present invention, each rotor assembly or rotor head may include a machined hub with provisions for blade attachment, a bearing, ring gears and hardware, rotating on a fixed support shaft with facing ring gears. A pinion assembly keyed to the support shaft separates them. This assembly may include a machined carrier, pinion gears, pins and associated bearings. The three assemblies are secured to the main support by a locking nut. Within the main support, the rotary shaft and bearing turns one of the rotor assemblies through a keyed drive cap. The rotational force is transferred by its ring gear to the idler pinions, which drive the second rotor's ring gear thus reversing its rotation.

The present invention may be adapted for use with a gyrocopter or helicopter and is capable of handling thrust forces of more then eight tons with a rotor head diameter of less then ten inches. In a free spinning gyrocopter and unlike a single rotor, the two counter rotating discs balance the lifting forces about the centerline of the craft and reduce the rotor diameter. The rotary shaft may be used as a spin up feature for a gyrocopter. Significantly, since the rotors counterbalance most of the torque forces, a rudder for a gyrocopter cancels the initial input torque allowing for vertical flight of the gyrocopter. In a rigid rotor helicopter, the addition of a horizontally actuated rudder in the rotor downwash cancels the input torque thus eliminating the mechanically complex tail rotor system. Notably, the spacing between the rotor discs is a function of the pinion/ring gear ratio, and can be modified as needed.

In the present invention, counter rotating blades double the working blade area without increasing the rotor disc. They also recover energy lost to the swirl of air emerging from a single disc. Counter rotating rotors therefore offer a performance advantage over a single rotor system. Scalable to virtually any size, potential applications include a wide range of aircraft and marine engines, gyrocopters, helicopters, unmanned aerial vehicles, fans, HVAC blowers, windmills and the like. For example, in a windmill application, the head works in reverse, where the counter rotating blades power a single output shaft to a dynamo.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a perspective view of a rotor head, in accordance with one embodiment of the present invention

FIG. 2 illustrates a drawing of a top view of a rotor head, in accordance with one embodiment of the present invention

FIG. 3 illustrates a drawing of a side view of a rotor head, in accordance with one embodiment of the present invention

FIG. 4 is a sectional side view of a rotor head taken along a longitudinal axis of the rotor head, in accordance with one embodiment of the present invention

FIG. 5 is a top view of a rotor/propeller hub of a rotor head, in accordance with one embodiment of the present invention

FIG. 6A illustrates a view of bevel gear idlers, idler pinion shafts, an idler pinion carrier and a main rotor shaft, in accordance with one embodiment of the present invention

FIG. 6B illustrates a drawing of a side view of an idler pinion shaft and an idler pinion carrier, in accordance with one embodiment of the present invention

FIG. 7A illustrates a drawing of a side sectional view through a bevel gear, in accordance with one embodiment of the present invention

FIG. 7B illustrates a drawing of a face of a bevel gear, in accordance with one embodiment of the present invention

FIG. 8A illustrates a drawing of a a side sectional view through a bevel gear idler, in accordance with one embodiment of the present invention

FIG. 8B illustrates a drawing of a face view of a bevel gear idler, in accordance with one embodiment of the present invention

FIG. 9A illustrates a drawing of an end view of a rotor input/output shaft, in accordance with one embodiment of the present invention

FIG. 9B illustrates a drawing of a side view of the rotor input/output shaft, in accordance with one embodiment of the present invention

FIG. 10A illustrates a drawing of a top view of a rotor drive cap, in accordance with one embodiment of the present invention

FIG. 10B illustrates a drawing of a side sectional view of the rotor drive cap, in accordance with one embodiment of the present invention

FIG. 11A illustrates a drawing of a partial view of one end of an idler pinion shaft, in accordance with one embodiment of the present invention

FIG. 11B illustrates a drawing of a side view of the idler pinion shaft, in accordance with one embodiment of the present invention

FIG. 11C illustrates a drawing of a an end view of the idler pinion shaft, in accordance with one embodiment of the present invention

FIG. 12A illustrates a drawing of a sectional view through a main rotor shaft, in accordance with one embodiment of the present invention

FIG. 12B illustrates a drawing of a partial view of an end of a main rotor shaft, in accordance with one embodiment of the present invention

FIG. 12C illustrates a drawing of an end view of the main rotor shaft, in accordance with one embodiment of the present invention

FIG. 12D illustrates a drawing of a side sectional view of the main rotor shaft, in accordance with one embodiment of the present invention

FIG. 13A illustrates a drawing of a bottom view of a rotor/propeller hub, in accordance with one embodiment of the present invention.

FIG. 13B illustrates a drawing of a side sectional view a rotor/propeller hub, in accordance with one embodiment of the present invention

FIG. 13C illustrates a drawing of a top view of a rotor/propeller hub, in accordance with one embodiment of the present invention

FIG. 14A illustrates a drawing of a side view of an idler pinion carrier, in accordance with one embodiment of the present invention

FIG. 14B illustrates a drawing of a side sectional view of the idler pinion carrier, in accordance with one embodiment of the present invention

FIG. 14C illustrates a drawing of a face of an idler pinion carrier, in accordance with one embodiment of the present invention

FIG. 15A illustrates a drawing of a side view of an application of a rotor head for a helicopter, in accordance with one embodiment of the present invention

FIG. 15B illustrates a drawing of a side view of an application of the rotor head for a boat, in accordance with one embodiment of the present invention

FIG. 16A illustrates a drawing of an application of the device for an enclosed turbine or ducted fan, in accordance with one embodiment of the present invention.

FIG. 16B illustrates a sectional view of a rotor head for an enclosed turbine or ducted fan, in accordance with one embodiment of the present invention.

FIG. 16C illustrates a perspective view of a rotor head for an enclosed turbine or a ducted fan, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

Throughout the present disclosure, it is to be understood that each of the components described herein may be made of any suitable material, such as metal, polymers, plastic, wood or the like or any suitable combination of these materials, as the particular application of the device warrants.

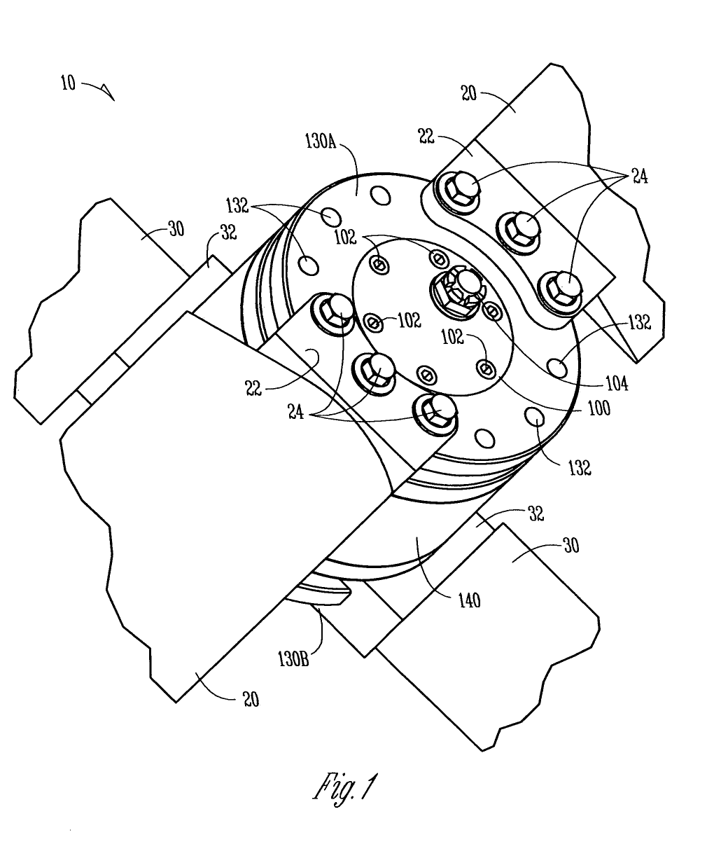

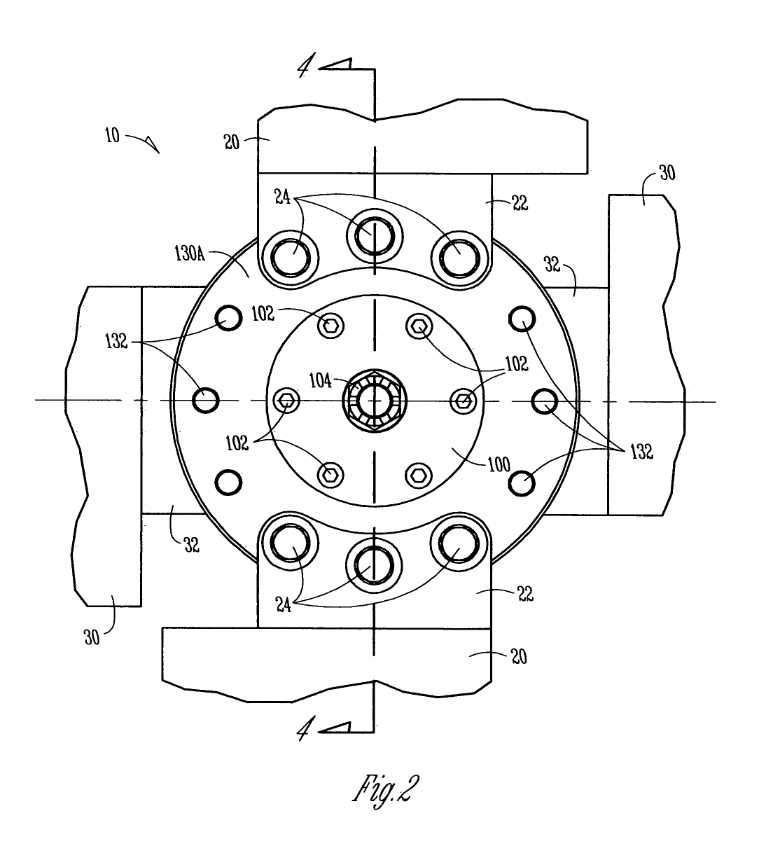

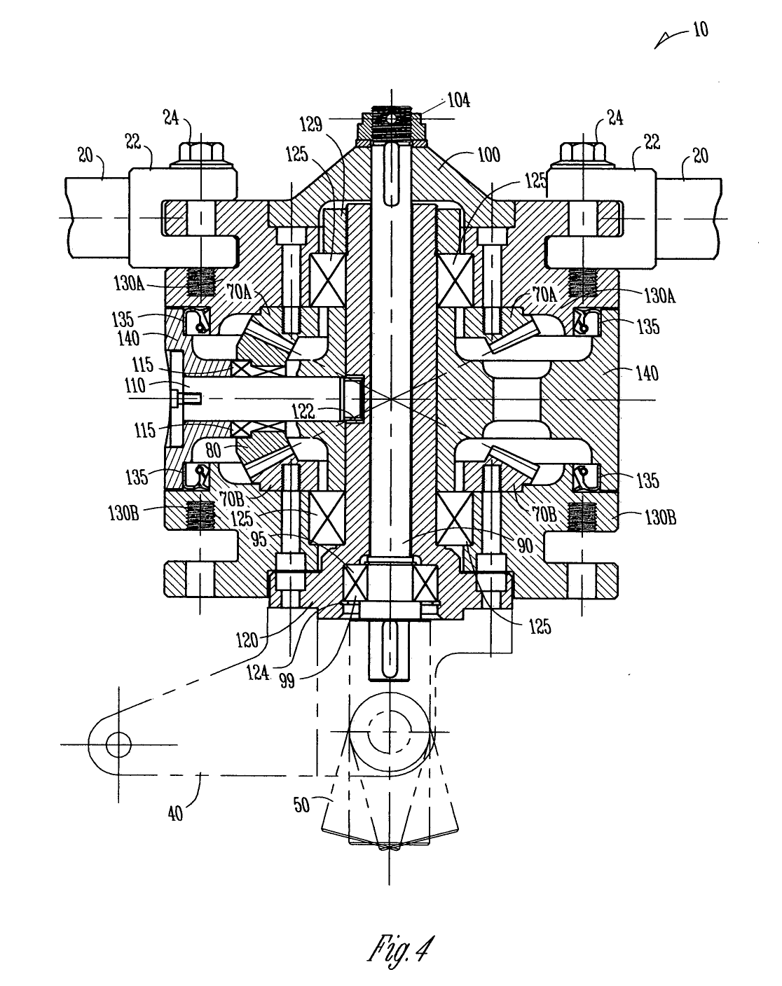

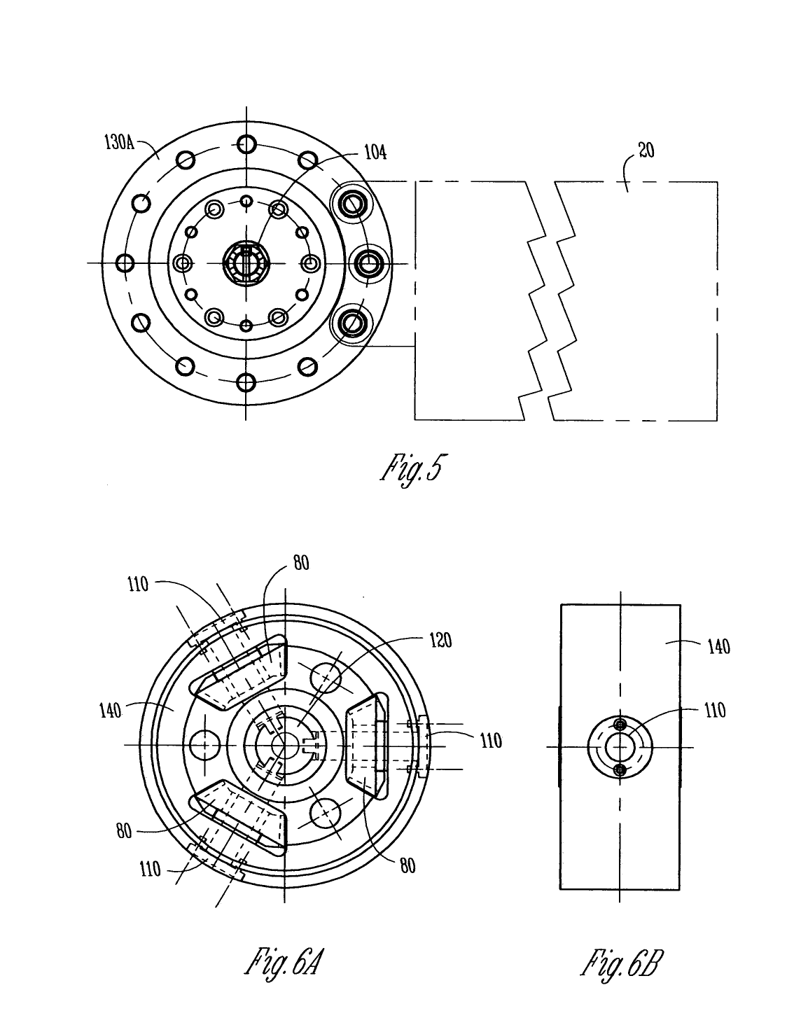

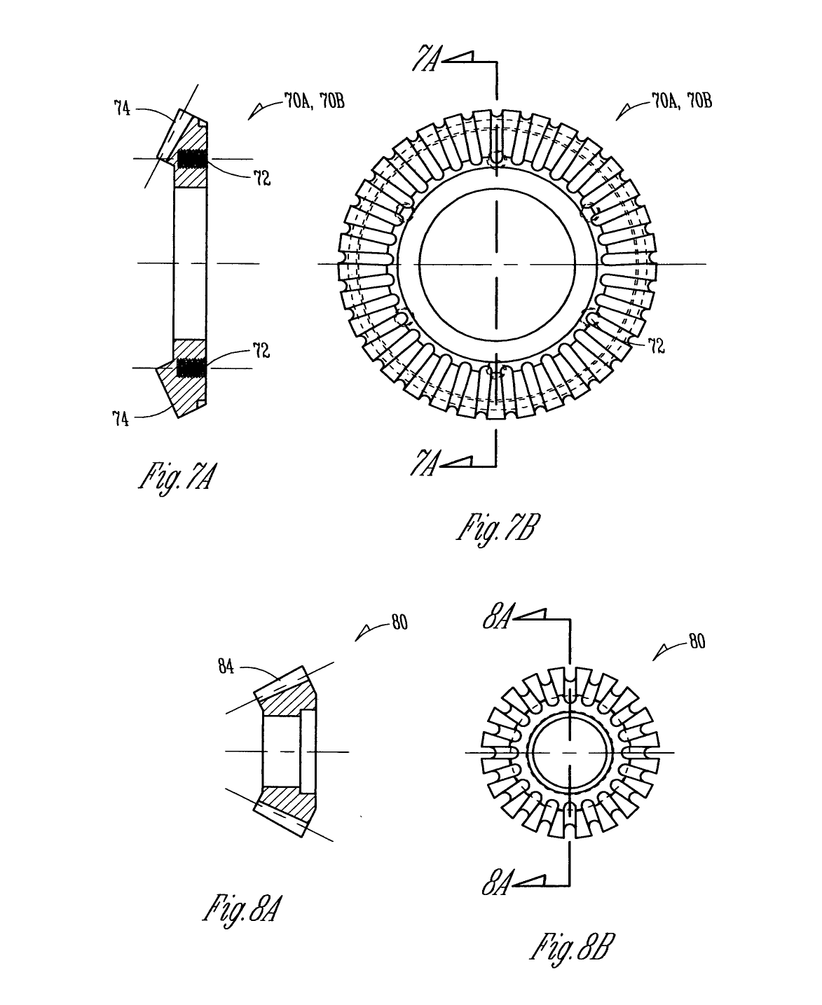

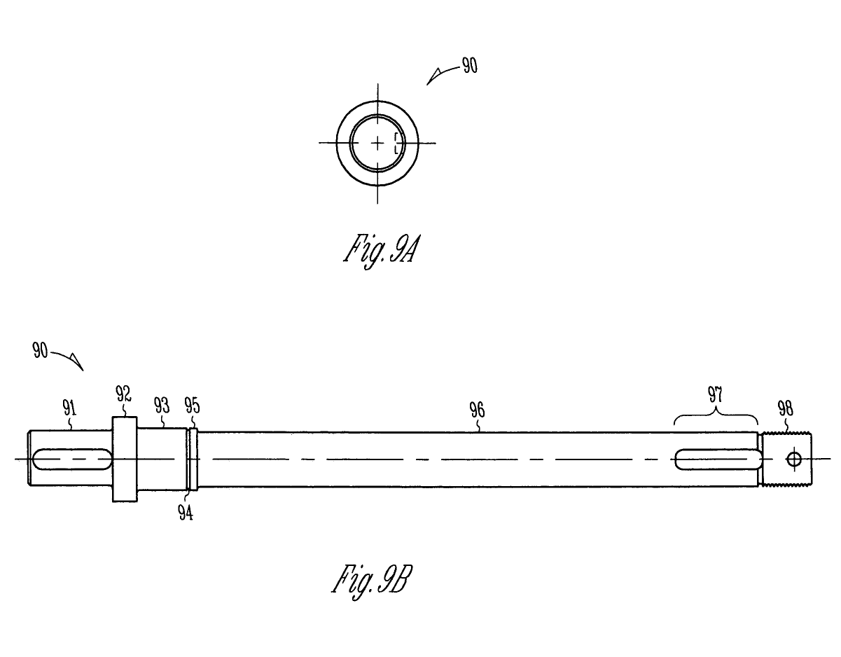

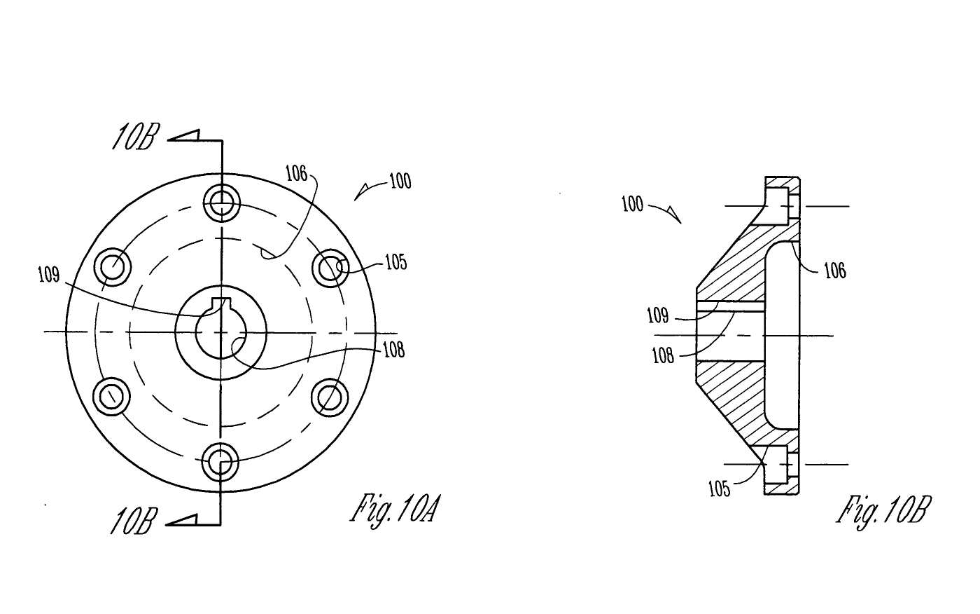

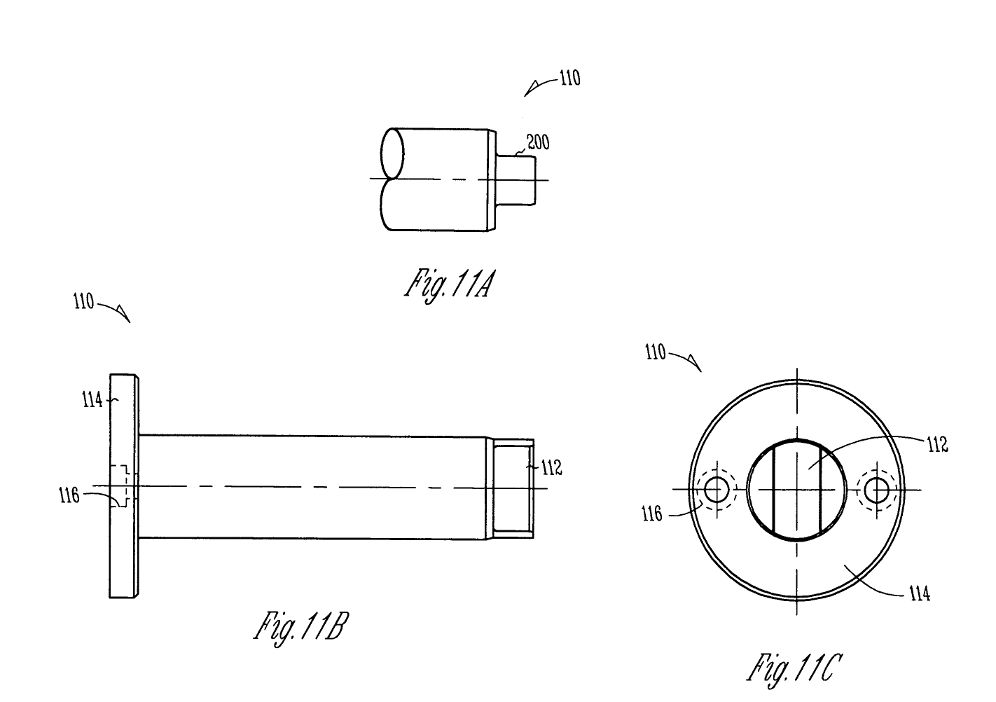

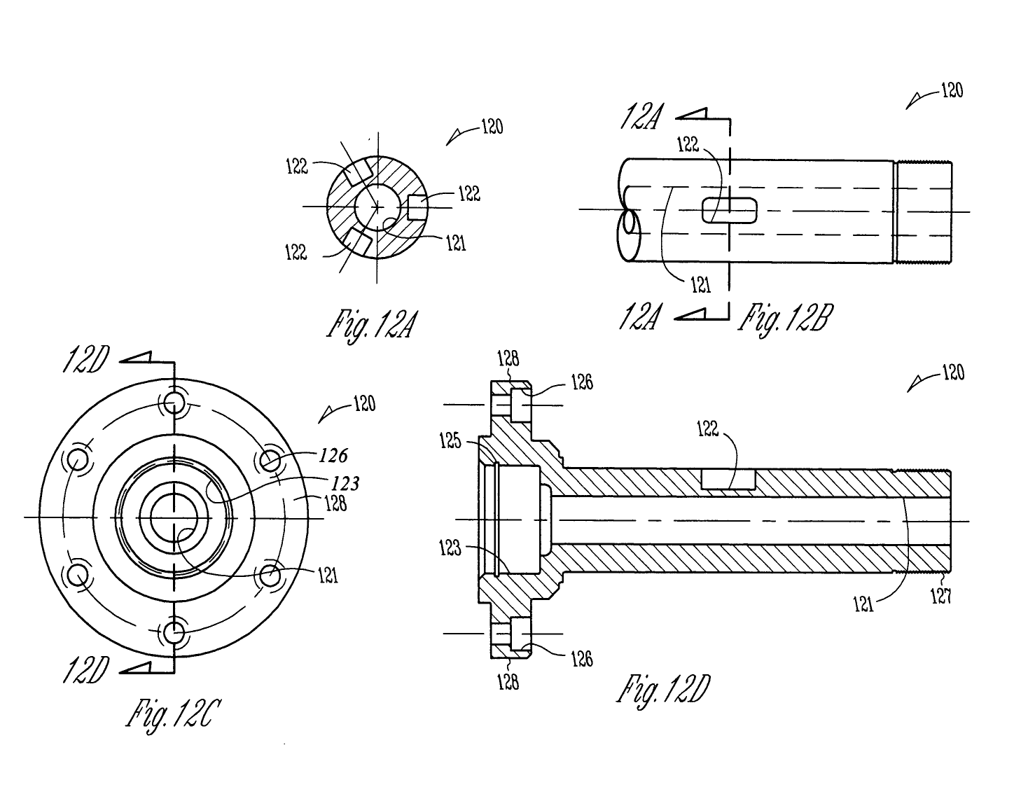

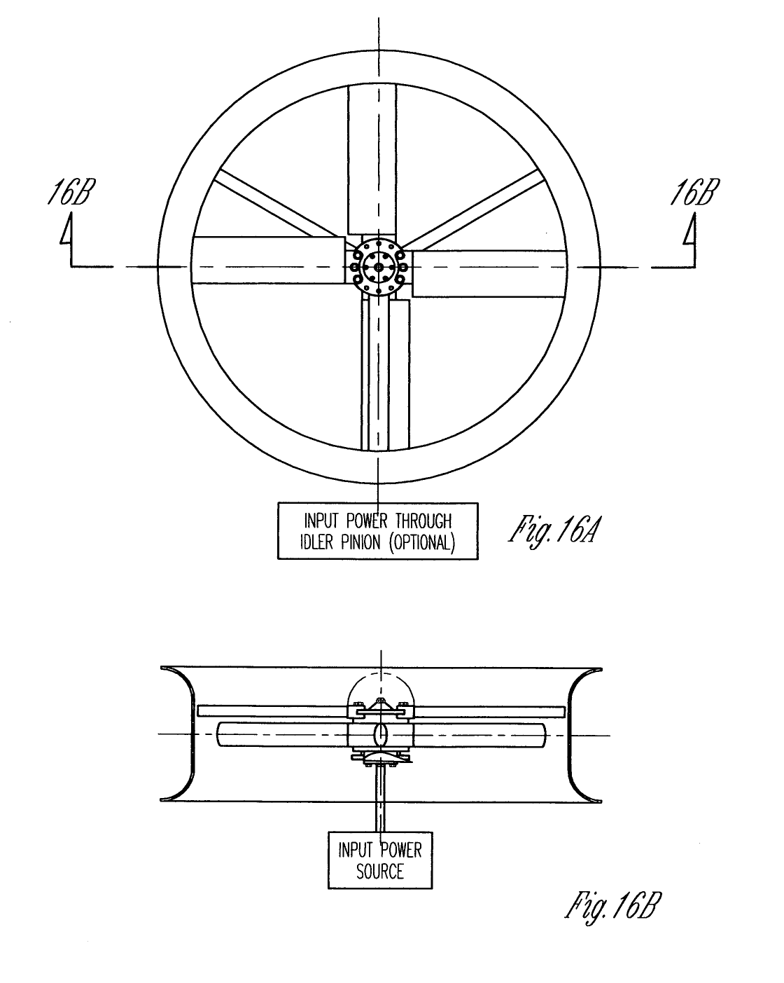

FIGS. 1-3 provide a perspective view, a side view and a top view, respectively, of one embodiment of the rotor head 10 of the present invention. As described in detail below, a rotor head 10 may comprise a rotor input/output shaft 90 (FIGS. 9A-9B), rotor drive cap 100 (FIGS. 1-4, 10A-10B), upper rotor/propeller hub 130A (FIGS. 1-5, 13A-13C), blades 20 (FIGS. 1-5) and driver bevel gear 70A (FIGS. 4, 7A-7B); an idler assembly comprising lower rotor/propeller hub 130B (FIGS. 1, 3, 4, 13A-13C), blades 30 (FIGS. 14) and idler bevel gear 70B (FIGS. 4, 7A-7B); and a static assembly comprising fixed support shaft or main rotor shaft or support 120 (FIGS. 4, 6A, 12A-12D), idler pinion carrier 140 (FIGS. 4, 6A-B, 14A-14C) and idler pinion shaft 110 (FIGS. 4, 6A-6B, 11A-11C). The driver assembly and the idler assembly rotate in opposite directions utilizing idler bevel gear 80 (FIGS. 4, 6A, 8A-8B) about the static assembly.

The rotor head 10 may be provided with a plurality of upper blades 20 and a plurality of lower blades 30 connected via a pair of rotor/propeller hubs 130A, 130B with an idler pinion carrier 140 between the rotor/propeller hubs 130A, 130B. The rotor/propeller hubs 130A, 130B and idler pinion carrier 140 will be described in greater detail below. Although pairs of upper and lower blades 20, 30 are shown, it is to be understood that any number of rotating members may be attached to the rotor head 10 of the present invention. For example, the blades 20, 30 could be any suitable means for moving a fluid such as air or water. That is, the blades 20, 30 could be helicopter blades, gyrocopter blades, fan blades, turbofan blades, turbine blades, compressor blades, windmill blades, propeller blades, vanes, and the like. The rotor head 10 could be adapted for use with air or land vehicles, devices requiring use of a fan, or any device utilizing rotating members. Although the blades are shown with a rounded leading edge cross-section and a sharp trailing edge cross-section, any suitable cross-sectional shape may be used for the blades 20, 30.

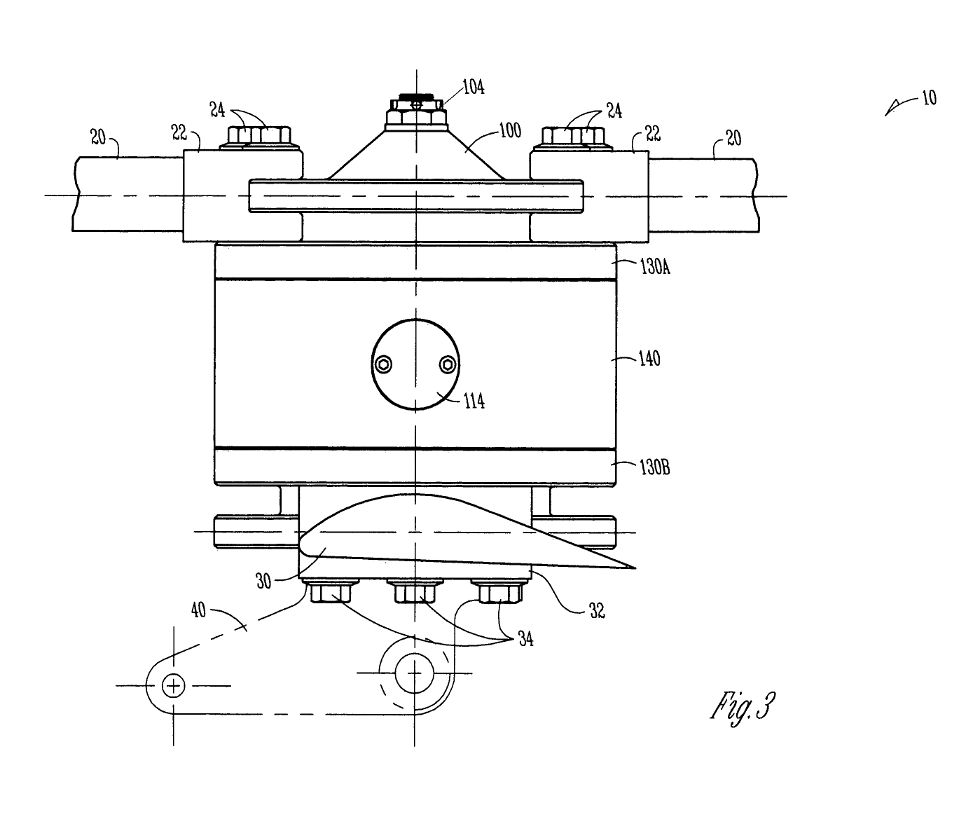

In one embodiment, as shown in FIGS. 3 and 4, the rotor head 10 may be attached (using any suitable means, not shown) to a vehicle, such as a helicopter (not shown), using base member 40 and rotating member 50. The base member 40 may be attached to a main rotor shaft 120 using any suitable means of connection. For example, base member 40 and support or fixed support shaft or shaft 120 may be attached using a bolted connection.

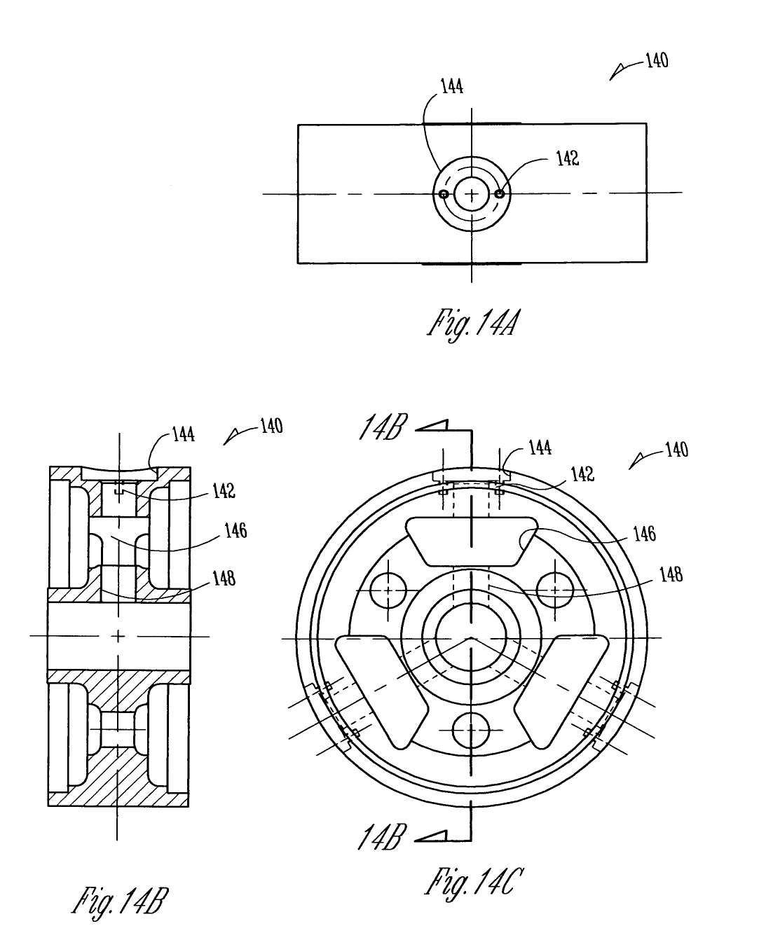

As shown in FIGS. 12A-12D, shaft 120 may have a radially extending flange portion 128 having a plurality of openings 126 therethrough. A plurality of bolts (not shown) may be adapted to pass through the openings 126 of the flange portion 128 of the shaft 120 and connect to a plurality of corresponding threaded recesses (not shown) in base member 40, which are adapted to receive the plurality of bolts (not shown). Although any suitable number of bolts may be used, six bolts may be provided to attach the shaft 120 to base member 40.

The shaft 120 may be provided with an axial opening 121 adapted to receive a rotor input/output shaft 90. Also, shaft 120 may be provided with a plurality of radial openings 122 adapted to receive one end of each of a plurality of idler pinion shafts 110. In one embodiment, three idler pinion shafts 110 may be provided as shown in FIG. 6A-6B, for example, and one end of each of the three idler pinion shafts 110 fits into a corresponding radial opening 122 in the shaft 120. Any suitable number of idler pinion shafts 110 and idler bevel gear 80 may be provided. The shaft 120 may be provided with a threaded end 127 to attach to a corresponding lock nut 129 (shown in FIG. 4). The lock nut 129 may be adapted to support a suitable means for rotation, such as bearings, provided in the space identified with the reference number 125. These bearings permit rotation between rotor/propeller hubs 130A, 130B and shaft 120. The rotor input/output shaft 90 may be adapted to rotate within the shaft 120. A suitable means for rotation, such as bearings, may be provided in the space identified with the reference number 99 to permit rotation between the rotor input/output shaft 90 and the main rotor shaft 120.

As shown in detail in FIGS. 9A-9B, the rotor input/output shaft 90 may have a first portion 91, a second portion 92, a third portion 93, a fourth portion 94, a fifth portion 95, a sixth portion 96, a seventh portion 97 and an eighth portion 98. First portion 91 may be adapted to rotate within base member 40. Second, third, fourth and fifth portions 92, 93, 94, 95 may be adapted to rotate within a corresponding axial opening 123 in main rotor shaft 120. The axial opening 123 may be provided with a groove 125 adapted to receive a lock ring 124. The lock ring 124 may be adapted to secure the means for rotation, such as bearings, provided in the space identified with the reference number 99. Sixth portion 96 may be adapted to rotate with axial opening 121 of main rotor shaft 120. Seventh portion 97 may be adapted to rotate within rotor drive cap 100. Eighth portion 98 may be adapted for threaded engagement with castle nut 104, which may be adapted to secure the rotor input/output shaft 90 to the rotor drive cap 100. As shown in FIG. 4, the bearings at reference number 99 may be held in place between second portion 92 and a snap ring held in fourth portion 94. Fifth portion 95 may be adapted to lock the rotor input/output shaft 90 into the corresponding opening 123 in the main rotor shaft 120.

As shown in FIGS. 1-4, 10A-10B, rotor drive cap 100 may be provided with a plurality of openings 105 for receiving a plurality of bolts 102 for attaching the rotor drive cap 100 to the upper rotor/propeller hub 130A. Essentially, rotor input/output shaft 90 may be statically connected to upper rotor/propeller hub 130A and driver bevel gear 70A thus permitting rotor input/output shaft 90, upper rotor/propeller hub 130A and driver bevel gear 70A to rotate together within and about main rotor shaft 120. Rotor drive cap 100 may be provided with a cap recess 106 adapted to provide a space for main rotor shaft 120 lock nut 129. Rotor drive cap 100 may also be provided with a second axial opening 108 to receive rotor input/output shaft 90. The rotor drive cap 100 may be provided with a key way 109 adapted for locking the rotor drive cap 100 to the rotor input/output shaft 90 using the castle nut 104. The blades 20, 30 may be connected to the pair of rotor/propeller hubs 130A, 130B using any suitable means of connection. For example, as shown in FIGS. 1-4 and 13B-13C, as in one embodiment each of the upper blades 20 may be attached to upper rotor/propeller hub 130A with a upper blade clevis 22 and a plurality of upper bolts 24. Similarly, each of the lower blades 30 may be attached to lower rotor/propeller hub 130B using a lower blade clevis 32 and a plurality of lower bolts 34. Although any suitable number of bolts 24, 34 may be used, three bolts 24, 34 may be provided for each blade 20, 30.

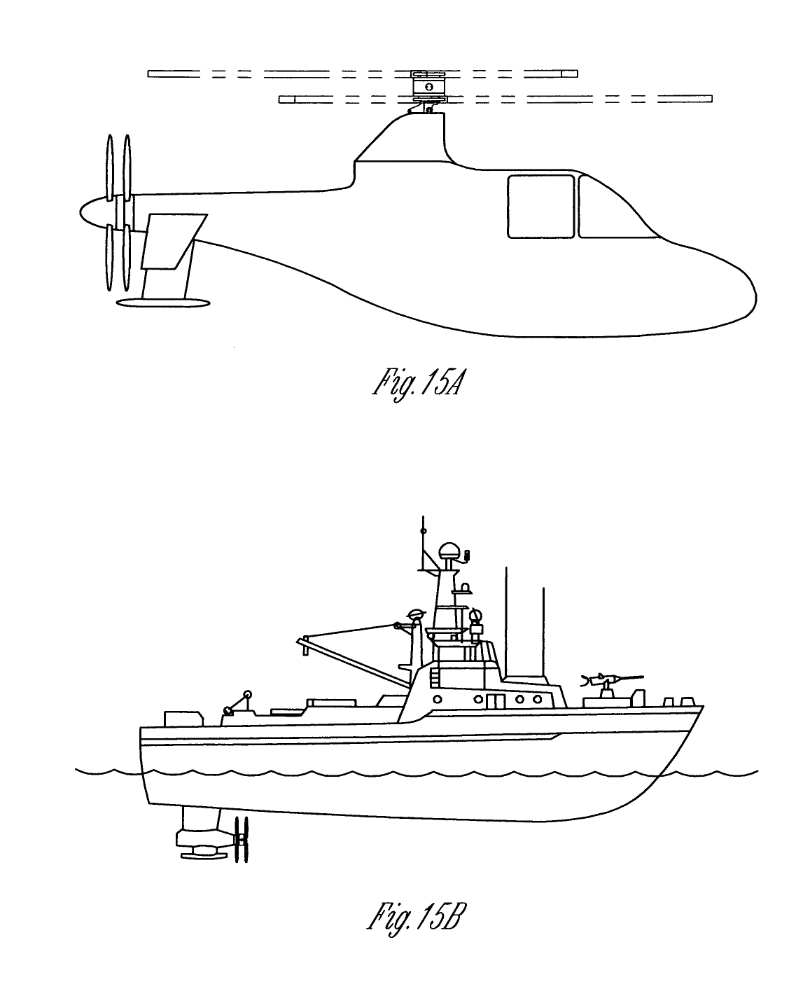

As shown in FIGS. 13A-13C, as in one embodiment, each of the rotor/propeller hubs 130A, 130B may include a first radially extending flange portion 134 having a plurality of openings 132 and a second radially extending flange portion 138 having a plurality of threaded recesses 138 adapted to receive the plurality of upper bolts 24 and lower bolts 34. Although any suitable number of openings 132 may be used, twelve openings 132 may be provided for the attachment of blades 20, 30. As shown in FIG. 4, the upper clevis 22, lower clevis 32 may attach to a flange portion of the rotor/propeller hubs 130A, 130B, and upper clevis 22, and lower clevis 32 may be adapted to fit on either side of the first flange portion 134 or any other appropriate location on first flange portion 134. Although not shown, it is to be understood that upper 22 and lower clevis 32 have openings adapted to receive the plurality of bolts 24, 34, respectively. Each of the rotor/propeller hubs 130A, 130B may be provided with an axial opening 133 adapted to receive main rotor shaft 120, and between which, as noted above, means for rotation may be provided, such as bearings in the location marked with reference number 125. Surface 139 of the rotor/propeller hubs 130A, 130B may be adapted to provide a surface for engagement with seals 135 (FIG. 4). Seals 135 are provided to seal the space, chamber or volume between rotor/propeller hubs 130A, 130B containing the lubricant for all the components and idler pinion carrier 140 are in the space. For example, a seal may be provided to keep the dirt and grime outside and lubrication inside, which may be fixed to the idler pinion carrier 140, and which has two engaging surfaces with each of the rotor/propeller hubs 130A, 130B; however, any suitable seal may be used.

As shown in FIGS. 7A-7B, each of the bevel gears 70A, 70B may be provided with a plurality of threaded recesses 72. The driver bevel gear 70A, the threaded recesses 72 are adapted to receive the bolts for attaching the driver bevel gear 70A through openings 131 to the upper rotor/propeller hub 130A. Although any suitable number of bolts may be used, six bolts are provided for attaching the driver bevel gear 70A through six openings 131 to the upper rotor/propeller hub 130A.

As noted above, driver bevel gear 70A may be adapted to rotate with the rotor input/output shaft 90 and rotates about the fixed support shaft 120. A driven bevel gear 70B may be provided below the driver bevel gear 70A. The driver bevel gear 70A rotates in a direction opposite to that of the driven bevel gear 70B. For the driven bevel gear 70B the threaded recesses 72 are adapted to receive bolts (not shown) for attaching the driven bevel gear 70B to lower rotor/propeller hub 130B through openings 137. Although any suitable number of bolts may be used, six bolts may be provided for attaching the driven bevel gear 70B through six openings 137 in the lower rotor/propeller hub 130B.

Each of the bevel gears 70A, 70B may be provided with a means to transfer torque to or from a plurality of idler bevel gear 80. Shown here are three idler bevel gears 80 however any number of idler bevel gears may be used and may be increased with increased loads. Of course only one idler bevel gear may be used and one or more may be used. The more idlers used the less load on each individual tooth of the idler gear. For example, a geared portion 74 may be provided to engage with a corresponding geared portion 84 of each of the plurality of idler bevel gear 80. The geared portion 74 may be provided at a generally obtuse angle with respect to the axis of the bevel gear 70. The geared portion 84 may be provided at a generally acute angle with respect to the axis of the idler bevel gear 80. The generally obtuse angle and the generally acute angle may be provided such that, in assembly, they add up to form a ninety degree angle. That said, any suitable angles may be provided for the geared portions 74, 84 depending on what ratios you use.

In operation, driver bevel gear 70A may be attached to rotor/propeller hub 130A that have blades 20 the rotor/propeller hub 130A may be attached to rotor input/output shaft 90. Driver bevel gear 70A drives the plurality of idler bevel gear 80, which rotate about idler pinion shaft 110, which, in turn, drives idler bevel gear 70B, which rotates with blades 30. Although gears are shown, any suitable means of transferring torque may be provided such as a traction drive and others.

As shown in FIGS. 4, 6A-6B, 8A-8B, a plurality of idler bevel gear 80 may be provided to transmit torque from the driver assembly to the idler assembly. Although three idler bevel gears 80 are shown in FIG. 6A-6B, any suitable number of idler bevel gear 80 may be provided. Each of the idler bevel gear 80 may be adapted to rotate about an idler pinion shaft 110.

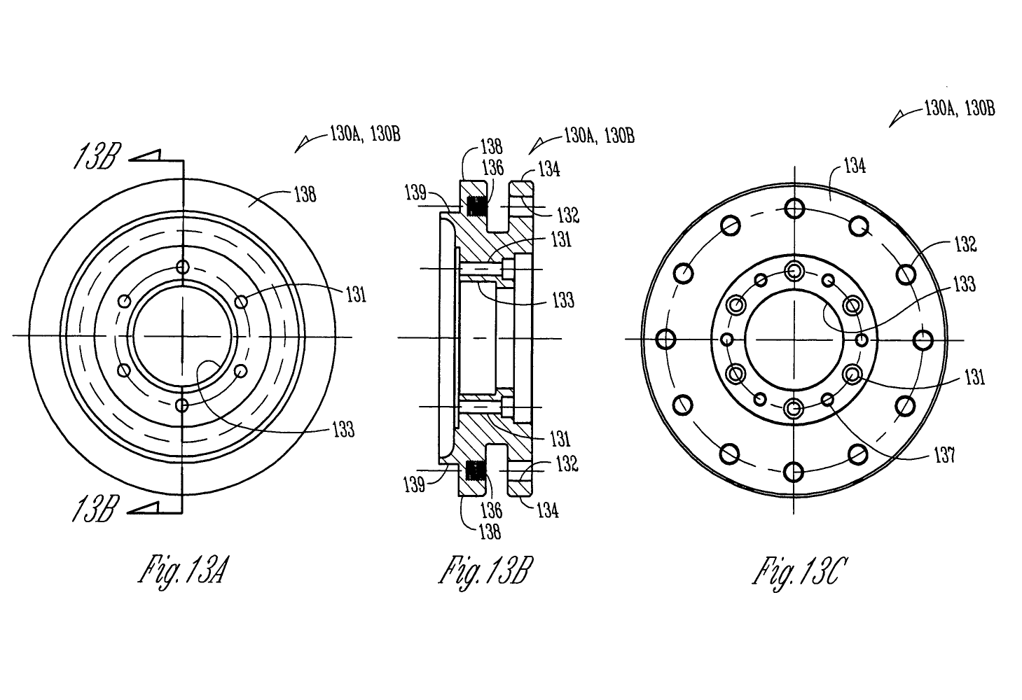

As shown in FIGS. 11A-11C, one end of each idler pinion shaft 110 may be provided with a key 112 adapted to fit inside opening 122 in fixed support shaft 120, and another end of each idler pinion shaft 110 may be provided with a head 114 adapted to lock the idler pinion shaft to the idler pinion carrier 140. As shown in FIG. 11C, the key 112 may have a generally rectangular cross-sectional shape with rounded short edges so as to provide stability in the connection with the fixed support shaft 120. Since the idler pinion shaft 110 may be subject to rotational forces from the bevel gears 70A, 70B, the key 112 provides additional structural stability to the idler assembly. The head 114 may be provided with a plurality of openings 116 adapted to receive bolts (not shown) which connect with corresponding threaded recesses 142 in generally cylindrical openings 144 provided on the exterior surface of idler pinion carrier 140. As such, idler pinion shaft 110 may be statically connected to the fixed support shaft 120 and the idler pinion carrier 140.

As shown in FIGS. 6A-6B and 14A-14C, idler pinion carrier 140 may be adapted to contain fixed support shaft 120, at least one idler bevel gear 80 and their corresponding idler pinion shafts 110. Threaded recesses 142 and openings 144 are described above. The idler bevel gear 80 is provided inside of internal cavities 146, and the pinion shafts 110 are provided inside of axial openings 148.

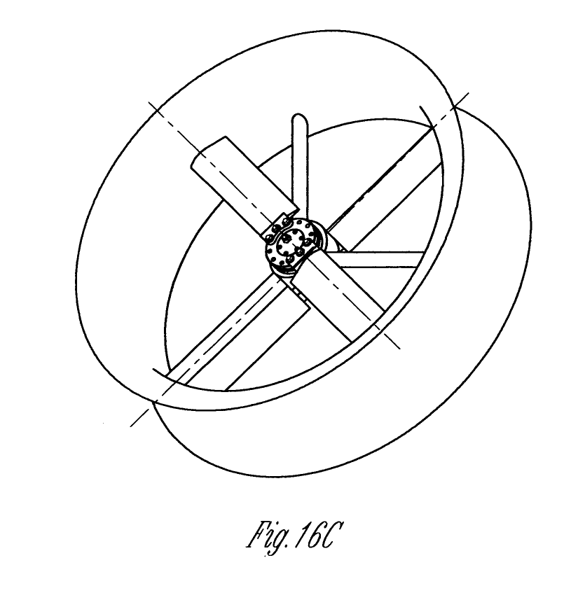

As shown in FIG. 15A, the device as shown in FIGS. 1-14C may be modified for use with a helicopter with or without pusher propellers. Specifically, the device may be attached to a drive shaft of the helicopter and used to drive the upper and lower counter rotating helicopter blades 20, 30. Further the drive shaft could be disengaged from the rotor head and the two pairs of upper and lower counter rotating helicopter blades 20, 30 could provide emergency lift in a free fail situation if a helicopter main power motor fails. In FIG. 15A the rotor head 10 may be modified for use in a gyrocopter specifically with the rotor head 10 having no power and using a pusher propeller.

As shown in FIG. 15B, the device as shown in FIGS. 1-14C may be modified for use with a boat. Specifically, the device may be attached to a drive shaft of the boat and used to drive two sets of counter rotating propeller blades.

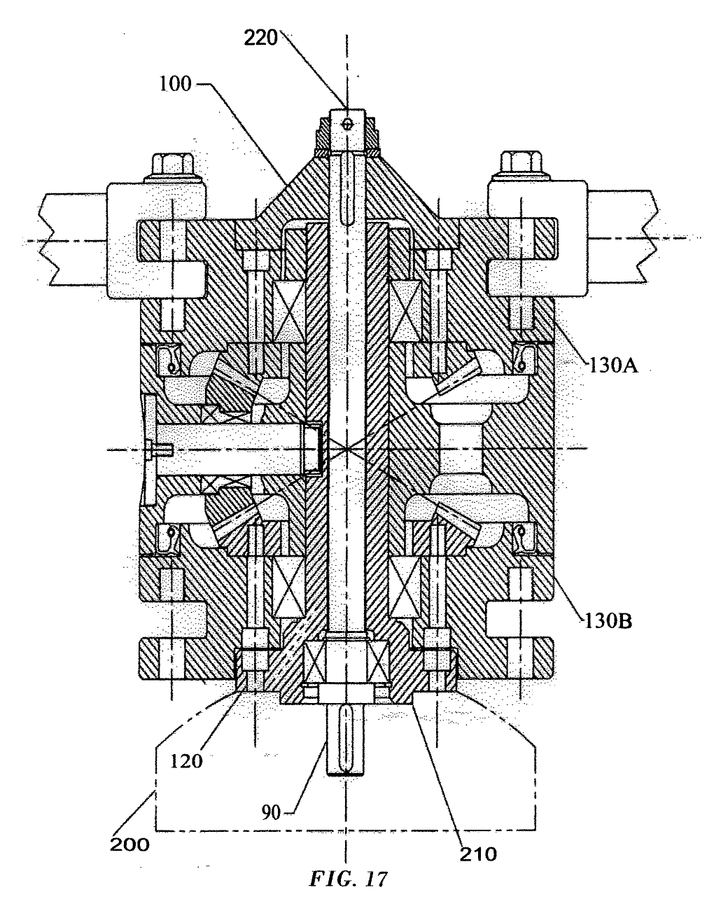

As shown in FIGS. 16A, 16B and 16C, the device as shown in FIGS. 1-14C may be modified for use with an enclosed turbine. Specifically, the device may be enclosed in a cowl, attached to a drive mechanism of a vehicle, and used to drive two pair of upper and lower counter rotating fan blades. Shown in FIG. 16A is the rotor head being powered through the idler pinion. In FIG. 16B shown is a rotor head being powered through the lower or second hub/ propeller.

In FIG. 17 as in one embodiment shown is cap 100 attached to 130A operablely connected to 130B. Main rotor shaft 120 supports cap 100, 130A and 130B. Input rotor shaft 90 may be positioned inside main rotor shaft 120. Vehicle structure 200 is where main rotor shaft 120 is attached. All or substantially all thrust forces 210 are transmitted to the vehicles structure 200 by trust bearings in the upper rotor hub 130A and lower rotor hub 130B through main rotor shaft 120. All or substantially all rotational force or torque 220 are transmitted to and from the upper rotor hub 130A and lower rotor hub 130B by the input/output shaft 90 through the cap 100.

Also, the present invention is directed to a device including a fixed support shaft or support 120, a first set of blades 20 operably connected to the support 120, and a second set of blades 30 counter rotating and operably connected to the first set of blades 20 and support 120, the operable connection is a first ring gear 70A on the first set of blades 20 and at least one idler pinion 110 fixed to the support 120 operably connected to a second ring gear 70B on the second set of blades 30.

The device may be provided such that an input/output shaft 90 is only an input shaft is inside the support 120 and connected to a cap 100, the cap 100 is connected to the first set of blades 20, and the input shaft 90 provides power and a spin up of the first set of blades 20 and second set of blades 30.

The device may be provided such that an input/output shaft 90 is only an output shaft is connected to the second set of blades 30 to power a generator (not shown). The device may be provided such that the first set of blades 20 and the second set of blades 30 are locked in phase so they spin together in a counter rotating direction.

The device may be provided such that the first set of blades 20 and the second set of blades 30 are mechanically connected to rotate in opposite directions. The device may be provided such that the ring gears 70A, 70B have thrust bearings. The device may be provided such that a universal joint 40 and a pivot 50 tilt the device forward and back.

Further, the present invention is directed to a rotor head comprising a first set of rotor blades 20 in a first direction, a first ring gear 70A connected to the first set of rotor blades 20, a idler bevel gear 80 connected to be driven by the first ring gear 70A, a second set of rotor blades 30 substantially coaxial with the first set of rotor blades 20, and a second ring gear 70B connected to drive the second set of rotor blades 30, the second ring gear 70B driven by the idler bevel gear 80 to rotate the second set of rotor blades 30 in a direction opposite to the direction of rotation of the first set of rotor blades 20.

Still further, the present invention is directed to a device comprising a first rotor 20 which rotates about a first axis in a first direction, a second rotor 30 which rotates about the first axis in a second direction opposite the first direction, a idler bevel gear 80 adapted to rotate about a second axis perpendicular to the first axis. The device may further comprise a first bevel gear 70A which rotates about the first axis in the first direction, a second bevel gear 70B which rotates about the first axis in the second direction.

The device may further comprise a fixed support shaft 120, a rotor shaft 90 connected to the fixed support shaft 120, the rotor shaft 90 adapted to rotate about the first axis in the first direction, a rotor drive cap 100 attached to the rotor shaft 90 which rotates about the first axis in the first direction, a first rotor hub 130A connected to the rotor drive cap 100 which rotates about the first axis in the first direction, the first rotor 20 connected to the first rotor hub 130A which rotates about the first axis in the first direction, the first bevel gear 70A connected to the first rotor hub 130A which rotates about the first axis in the first direction, an idler pinion carrier 140 connected to the fixed support shaft 120, an idler pinion shaft 110 connected to the idler pinion carrier 140, the idler bevel gear 80 adapted to rotate about the second axis, the second axis perpendicular to the first axis, the idler bevel gear 80 connected to the first bevel gear 70A, the second bevel gear 70B and the idler pinion 110 shaft, the idler bevel gear 80 adapted to rotate about the second axis, the second bevel gear 70B connected to a second rotor hub 130B which rotates about the first axis in the second direction, the second rotor hub 130B connected to the second bevel gear 70B which rotates about the first axis in the second direction, and the second rotor 30 connected to the second rotor hub 1 30B which rotates about the first axis in the second direction.

Even further, the present invention is directed to methods for manufacturing each of the devices detailed above. Each of the features described in the methods below have been described in detail above and in the attached FIGS. 1-16C.

The method may comprise providing a first rotor which rotates about a first axis in a first direction; providing a second rotor which rotates about the first axis in a second direction opposite the first direction; and providing a bevel gear idler adapted to rotate about a second axis perpendicular to the first axis.

The method may further comprise providing a first bevel gear which rotates about the first axis in the first direction and providing a second bevel gear which rotates about the first axis in the second direction. The method may further comprise providing a main rotor shaft; providing a rotor shaft connected to the main rotor shaft, the rotor shaft adapted to rotate about the first axis in the first direction; providing a rotor drive cap attached to the rotor shaft which rotates about the first axis in the first direction; and providing a first rotor hub connected to the rotor drive cap which rotates about the first axis in the first direction.

The method may further comprise connecting the first rotor to the first rotor hub which rotates about the first axis in the first direction; and connecting the first bevel gear to the first rotor hub which rotates about the first axis in the first direction. The method may further comprise providing an idler pinion carrier connected to the main rotor shaft; and providing an idler pinion shaft connected to the idler pinion carrier, the bevel gear idler adapted to rotate about the second axis, the second axis perpendicular to the first axis.

The method may further comprise connecting the bevel gear idler to the first bevel gear, the second bevel gear and the idler pinion shaft, the bevel gear idler adapted to rotate about the second axis; connecting the second bevel gear to a second rotor hub which rotates about the first axis in the second direction; connecting the second rotor hub to the second bevel gear which rotates about the first axis in the second direction; and connecting the second rotor to the second rotor hub which rotates about the first axis in the second direction.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

1-20. (canceled)

21. A device comprising:
a support;
a sealed housing for oil around the support, the sealed housing includes an idler pinion carrier, seals and two rotor hubs;
a first set of blades operably connected to the support; and
a second set of blades counter rotating and operably connected to the first set of blades and the operable connection between the first and second set of blades is a first ring gear on the first set of blades operably connected to at least one idler pinion fixed to the support the at least one idler pinion operably connected to a second ring gear on the second set of blades.

22. The device of claim 21 wherein an input shaft is inside the support and connected to a cap, the cap connected to the first set of blades, the input shaft provides power and a spin up to the first set of blades and second set of blades.

23. The device of claim 21 wherein an output shaft is connected to the second set of blades to power a generator.

24. The device of claim 21 wherein the first set of blades and the second set of blades are locked in phase so they spin together in a counter rotating direction.

25. The device of claim 21 wherein the support is a main rotor shaft that is hollow and encloses an input rotor shaft.

26. The device of claim 21 wherein the ring gears have thrust bearings.

27. The device of claim 21 wherein a universal joint and a pivot tilts a rotor head forward and back.

28. A device comprising:
a first rotor which rotates about a first axis in a first direction;
a sealed housing for oil around the support, the sealed housing includes an idler pinion carrier, seals, two rotor hubs, bearings having seals, and pins having a selected one of a gasket and 0 ring seal;
a second rotor which rotates about the first axis in a second direction opposite the first direction; and
a bevel gear idler adapted to rotate about a second axis perpendicular to the first axis.

29. The device of claim 28 wherein a first bevel gear which rotates about the first axis in the first direction; and
a second bevel gear which rotates about the first axis in the second direction.

30. The device of claim 29 wherein a main rotor shaft;
a rotor shaft connected to the main rotor shaft, the rotor shaft adapted to rotate about the first axis in the first direction;
a rotor drive cap attached to the rotor shaft which rotates about the first axis in the first direction; and
a first rotor hub connected to the rotor drive cap which rotates about the first axis in the first direction;

31. The device of claim 30 wherein the first rotor is connected to the first rotor hub which rotates about the first axis in the first direction and the first bevel gear is connected to the first rotor hub which rotates about the first axis in the first direction.

32. The device of claim 30 wherein
an idler pinion carrier connected to the main rotor shaft; and
an idler pinion shaft connected to the idler pinion carrier, the bevel gear idler adapted to rotate about the second axis, the second axis perpendicular to the first axis.

33. The device of claim 32 wherein the bevel gear idler is connected to the first bevel gear, the second bevel gear and the idler pinion shaft, the bevel gear idler adapted to rotate about the second axis the second bevel gear is connected to a second rotor hub which rotates about the first axis in the second direction the second rotor hub is connected to the second bevel gear which rotates about the first axis in the second direction and the second rotor is connected to the second rotor hub which rotates about the first axis in the second direction.

34. A method of counter rotating a plurality hubs comprising:
rotating a first hub;
a sealed housing for oil around the support, the sealed housing includes an idler pinion carrier, seals, two rotor hubs, bearings having seals, and pins having a selected one of a gasket and 0 ring seal;
connecting the first hub to a second hub by at least one idler and two ring gears to cause the first and second hub to rotate in opposite directions; and
supporting the first hub, second hub and the at least one idler by a main rotor shaft.
35. The method of claim 34 wherein connecting a cap to the first hub causing the cap to rotate in the same direction as the first hub.

36. The method of claim 34 wherein rotating an output shaft by way of the output shaft being connected to a cap the cap connected to the first hub.

37. The method of claim 34 wherein rotating an input rotor shaft that is connected to a cap the cap is connected to the first hub the input rotor shaft drives the first hub.

38. The method of claim 34 wherein fixing the main rotor shaft to a vehicle.

39. The method of claim 34 wherein rotating an input rotor shaft that is connected to a cap the cap is connected to the first hub the input rotor shaft drives the first hub the input rotor shaft is inside the main rotor shaft.

40. The method of claim 34 wherein the main rotor shaft is hollow.
